(19) United States
(12) Patent Application Publication
(10) Pub. No.: US 2026/0150827 A1
(43) Pub. Date: Jun. 4, 2026

(54) Fishing Line with Carbon Nanotube Fibers

(71) Applicant: Kureha America, Inc., Houston, TX (US)

(72) Inventor: Tatsuya YAGUCHI, Houston, TX (US)

(73) Assignee: Kureha America, Inc., Houston, TX (US)

(21) Appl. No.: 18/962,395

(22) Filed: Nov. 27, 2024

Related U.S. Application Data
(60) Provisional application No. 63/604,481, filed on Nov. 30, 2023.

(51) Int. Cl. A01K 91/00; C01B 32/174

(52) U.S. Cl. CPC A01K 91/00; C01B 32/174

(57) ABSTRACT

A fishing line includes a carbon nanotube (CNT) filament that includes a CNT phase. The CNT phase includes CNTs extending along a longitudinal direction of the CNT filament. The fishing line has a tensile strength greater than or equal to 1 [GPa]. The CNT filament may further include a support phase that includes a support material.

### BACKGROUND

Conventional plastic and metal fishing lines are susceptible to failure due to the many hazards in rivers and oceans. Physical hazards (e.g., sharp teeth, abrasive scales, gill plates, oyster beds, barnacles, corals) can cut plastic fishing lines. Furthermore, abrasion resistant metal fishing lines are susceptible to mechanical failure due to kinks and corrosion in aqueous environments. A fishing line that combines the features of cut and abrasion resistance, tensile strength, and flexibility is desirable.

### SUMMARY

In general, one or more embodiments of the invention relate to a fishing line comprising: a carbon nanotube (CNT) filament that includes a CNT phase. The CNT phase includes CNTs extending along a longitudinal direction of the CNT filament. the fishing line has a tensile strength greater than or equal to 1 [GPa].

In general, one or more embodiments of the invention relate to a method of fabricating a fishing line. The method includes: preparing a carbon nanotube (CNT) material; forming a CNT filament from the CNT material, wherein a CNT phase of the CNT filament includes CNTs extending along a longitudinal direction of the CNT filament; and winding the fishing line on a spool. The fishing line is formed with a tensile strength greater than or equal to 1 [GPa].

Other aspects of the invention will be apparent from the following description and the appended claims.

### BRIEF DESCRIPTION OF DRAWINGS

FIG. 1 shows a conventional fishing line.

FIG. 2 shows a fishing line, in accordance with one or more embodiments.

FIGS. 3A-3C each show a multi-phase fishing line, in accordance with one or more embodiments.

FIG. 4 shows a multi-phase fishing line, in accordance with one or more embodiments.

FIGS. 5A-5B each show a multi-filament fishing line, in accordance with one or more embodiments.

FIGS. 6-7 show flowcharts of methods for fabricating a fishing line according to one or more embodiments.

FIG. 8 shows a system for fabricating a fishing line according to one or more embodiments.

FIGS. 9A-9C show subsystems for fabricating a fishing line according to one or more embodiments.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third) may be used as an adjective for an element (i.e., any noun in the application). The use of ordinal numbers is not to imply or create a particular ordering of the elements nor to limit any element to being only a single element unless expressly disclosed, such as by the use of the terms “before,” “after,” “single,” and other such terminology. Rather the use of ordinal numbers is to distinguish between the elements. By way of an example, a first element is distinct from a second element, and the first element may encompass more than one element and may succeed (or precede) the second element in an ordering of elements.

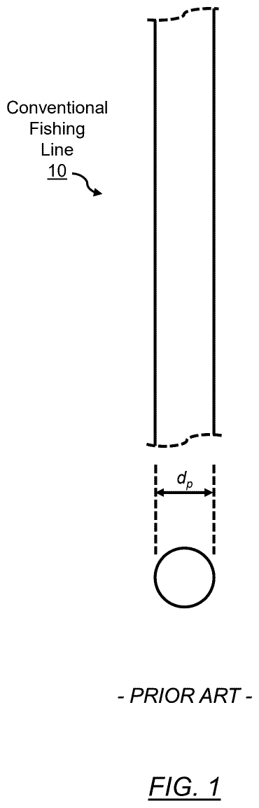

Fishing lines are typically categorized into monofilament and multifilament in the view of filament structures. FIG. 1 shows an example of conventional fishing line 10, which consists of a monofilament.

The conventional fishing line 10 typically consists of a single homogeneous material, such as polymer (e.g., polyethylene (PE), nylon, polyvinylidene fluoride (PVDF)). However, polymer materials are susceptible to being cut on underwater hazards (e.g., coral, rocks, barnacles, shells, oyster beds) or by animals (e.g., abrasive scales, gill plates, sharp teeth).

To mitigate cutting of a polymer conventional fishing line 10, a metal material (e.g., stainless steel) may be used to provide increased strength and abrasion resistance. However, metal materials are susceptible to kinks and bends that drastically reduce the tensile strength of the conventional fishing line 10 and may result in the line cutting. Furthermore, metal materials eventually corrode in aqueous environments, resulting in the conventional fishing line 10 becoming unusable.

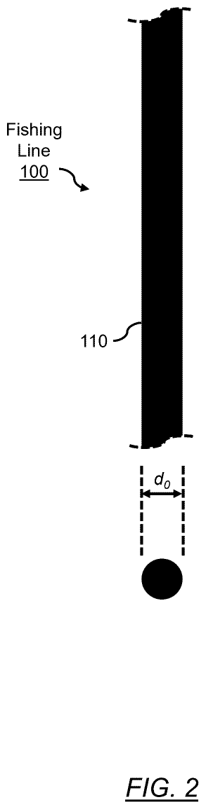

FIG. 2 shows a fishing line 100, in accordance with one or more embodiments.

The fishing line 100 comprises a carbon nanotube (CNT) filament 110 that includes a CNT phase. The CNT phase includes a plurality of CNTs. Each of CNTs is oriented along the longitudinal direction of the CNT filament 110 and adheres to each other longitudinally and diametrically to form an elongated bundle-like structure. CNTs are tubular carbon nanoscale structures that exhibit remarkable properties, such as exceptional tensile strength, flexibility, and thermal conductivity. While individual CNTs have diameters in the nanoscale regime, a CNT solution can be formed into a macroscopic CNT phase (e.g., a macroscopic proto-product, fiber, film, bulk material). In one or more embodiments, the purity of CNTs in the CNT phase is at least about 75%, at least about 85%, at least about 90%, or at least about 95%. The CNT phase may then be processed and shaped into a final form such as the CNT filament 110 with a macroscopic diameter do.

The CNT filament 110 that constitutes the fishing line 10 may be a monofilament which is formed of a single CNT filament 110 or a multifilament formed from a plurality of CNT filaments 110 braided together. While a circular cross-section is shown, the cross-section of the CNT filament 110 may be any shape. Within the CNT phase, the CNTs extend along a longitudinal direction of the CNT filament 110 to provide tensile strength to the fishing line 100. Due to the van der Waals interaction, there is a friction among CNTs that constitute the CNT phase. The tensile strength of the CNT filament 110 usually depends on the friction among CNTs, rather than the strength of constituent CNTs in the tensile fracture process. Therefore, a CNT assembly morphology of the CNT filament 110 is the critical factor affecting the tensile strength of the CNT filament 110. By orienting the CNTs in one direction, the van der Waals force and the frictional force between the CNTs are increased, resulting in the tensile strength equal to or greater than that of conventional metal fishing lines. In one or more embodiments, the tensile strength of the fishing line 100 may be greater than or equal to 1 [GPa] (i.e., 1.0×10⁹ [Pa]).

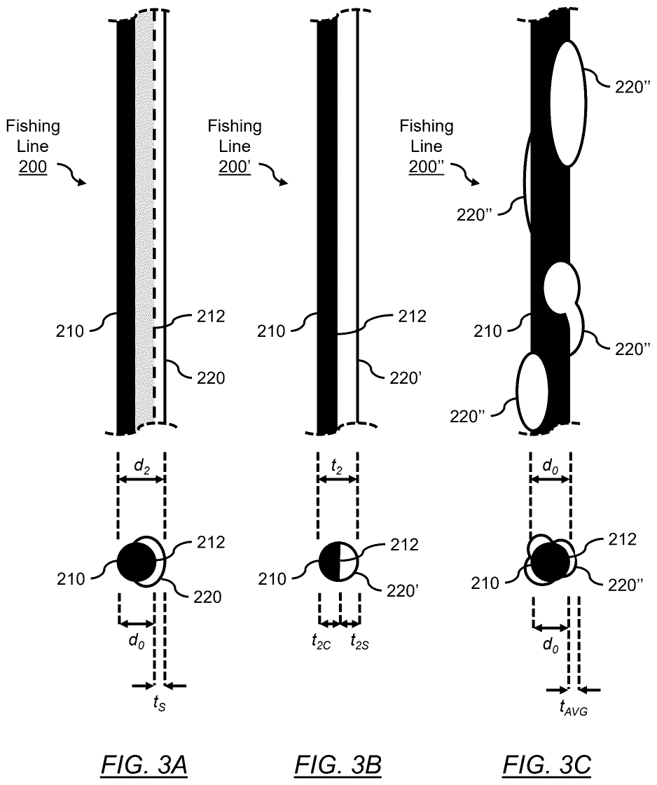

FIGS. 3A-3C each show a multi-phase fishing line 200, in accordance with one or more embodiments.

In FIGS. 3A-3C, the fishing line 200 includes: a CNT filament 210 comprising the CNT phase; and a support phase 220, comprising a support material, that at least partially covers the CNT phase along the longitudinal direction of the fishing line. Each of these components is described in further detail below.

The CNT filament 210 may be the same as the CNT filament 110 described above. In one or more embodiments, the CNT filament 210 may further include a treated surface 212. The treated surface 212 may be chemically and/or mechanically treated to improve one or more characteristics of the CNT filament 210. For example, adhesion between the CNT filament 210 and the support phase 220 may be promoted by preparing the treated surface 212.

In one or more embodiments, the treated surface 212 may be plasma treated or corona treated (e.g., exposed one or more times to a plasma or corona environment). Plasma or corona treatment effectively enhances the adhesion of CNT to support materials by introducing hydrophilic functional groups, increasing the contact area, and strengthening the attractive forces between the CNT and the support materials. The hydrophilic functional groups may include a hydroxyl group, a carbonyl group, an aldehyde group, and a carboxyl group. For example, plasma etching the treated surface 212 may improve adhesion between the CNT filament 210 and the support phase 220 and/or prevent it from detaching from the CNT filament 210.

In one or more embodiments, the treated surface 212 may be chemically treated (e.g., exposed one or more times to a liquid etching solution and/or gaseous etching compound). For example, chemical etching with piranha solution (KOH, H₂O₂+H₂SO₄) may introduce surface hydrophilic functional groups to the treated surface 212. The hydrophilic functional groups may include a hydroxyl group, a carbonyl group, an aldehyde group, and a carboxyl group. Chemical treating may include impregnating the CNT filament 210 with a chemical activator or bonding precursor.

In one or more embodiments, the treated surface 212 may be mechanically abraded, etched, or otherwise roughened. By introducing surface roughness, bonding of the support phase 220 to the treated surface 212 may be improved.

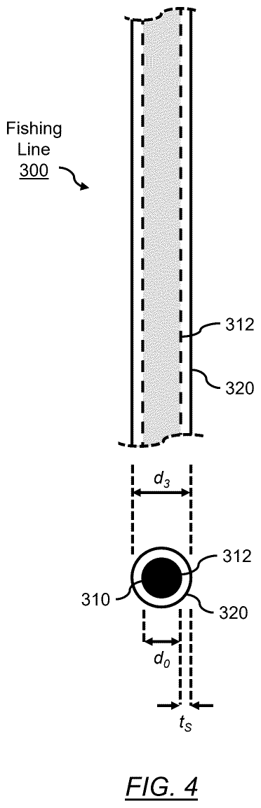

The treated surface 212 may be any portion of the total surface area of the CNT filament 210 (e.g., coated or not coated with support phase 220). In one or more embodiments, the treated surface 212 may include the entire surface area of the CNT filament 210, as discussed in further detail below with respect to FIG. 4. In one or more embodiments where the treated surface 212 does not include the entire surface area of the CNT filament 210, the treated surface 212 may be a single contiguous region along the CNT filament 210.

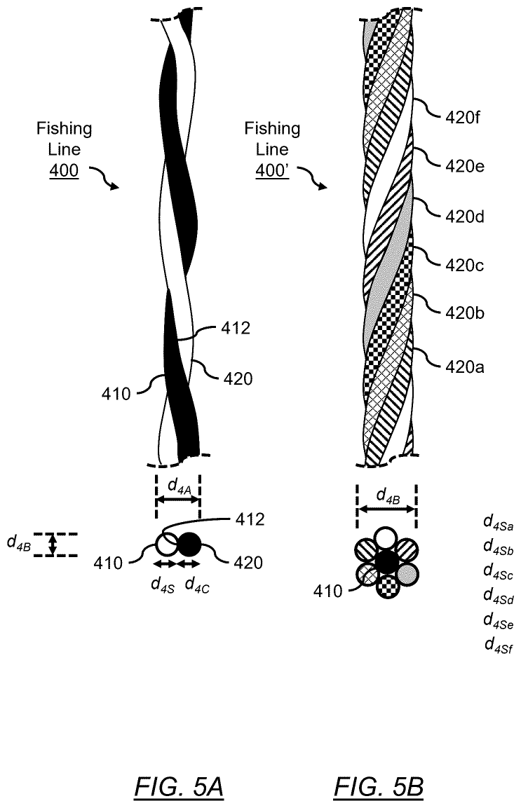

The support phase 220 includes a support material. The support material may include a synthetic polymer, a natural polymer, a ceramic, a metal, a carbon material other than the carbon nanotubes, or any combination thereof. Non-limiting examples of a support material include: fluoropolymers (e.g., polytetrafluoroethylene, polyvinylidene difluoride), nylons (e.g., nylon 6, nylon 66, nylon 4), polyolefins (e.g., high-density polyethylene, low-density polyethylene, polypropylene), polyesters (e.g., polyethylene terephthalate, polylactic acid, polyglycolic acid), polyphenylene sulfide, epoxy, polyurethane, polyacrylic acid, natural polymers (e.g., polypeptides, celluloses), ceramics (e.g., alumina, silica), metals (e.g., copper, stainless steel, aluminum), and carbon materials (e.g., PAN-based carbon, isotropic-pitch-based carbon, mesophase-pitch-based carbon). In one or more embodiments, the support phase 220 may have a specific gravity greater than the CNT phase, and the support material forming the support phase 220 may include fluoropolymers, ceramics, and/or metals. Fishing lines going faster under water can easily keep rigs around the desired location (e.g., rapid sinking at the desired casting location). Therefore, the greater specific gravity of fishing lines may be advantageous to some anglers. For example, multiple instances of a single material or multiple different materials may be combined to form the support phase 220, as further described with respect to FIG. 5B below.

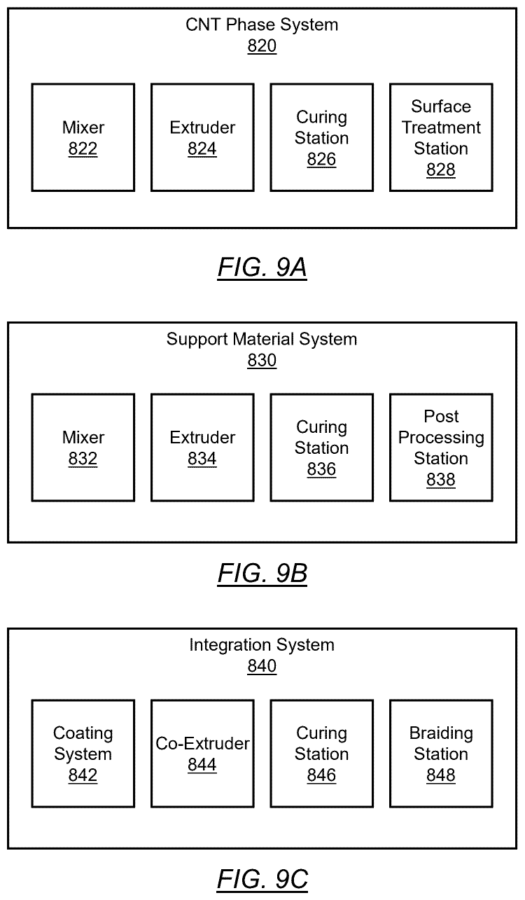

In one or more embodiments, the support phase 220 may undergo post-processing treatments (e.g., etching/abrading to improve/alter surface functionalization, contact area, material properties) to create a corresponding treated surface, as described below with reference to FIG. 9B.

As shown in FIG. 3A, a CNT filament 210 with a circular cross section of diameter d₂ is partially coated with the support phase 220. While the CNT filament is shown with a circular cross-section, any cross-sectional shape may be used. The support phase 220 may be coated on one or more sides of the CNT filament 210 or may wrap (e.g., spiral, wave-like, nonlinear coating stripe) around the CNT filament 210 (not shown). The thickness t_{S} of the support phase 220 adds to the diameter d₀ of the CNT filament 210 to increase the fishing line 200 to an overall diameter of d₂.

As shown in FIG. 3B, the CNT filament 210 may be co-formed with the support phase 220′. For example, the CNT phase and the support phase 220 may be extruded together to form a fishing line 200′ with a predetermined cross-sectional shape (e.g., circular as shown, but any shape may be used). By forming a known predetermined shape, the winding of the fishing line 200′ may be improved over other irregular geometries. The relative amount of each phase (e.g., thickness, cross-section area percentage, mass, volume) may be constant or may vary along the length of the fishing line 200′. For example, the thickness t_{2C}, t_{2S} for the CNT filament 210 and support phase 220, respectively, may be equal to create a balanced bi-material fishing line 200′ of overall thickness t₂.

As shown in FIG. 3C, the CNT filament 210 may be partially coated with discontinuous portions of the support phases 220. For example, in contrast with the continuous structure of the support phase 220, 220′ shown in FIGS. 3A-3B, a support material may be sprayed or sputtered onto the CNT filament 210 to form the support phase 220″. The average thickness t_{AVG} of the support phase 220″ (thickness of the individual portions of the support phase 220″ may not be consistent) may increase the overall diameter of the fishing line 200″ relative to the diameter d₀ of the CNT filament 210.

FIG. 4 shows a multi-phase fishing line 300, in accordance with one or more embodiments.

In FIG. 4, the fishing line 300 includes: a CNT filament 310 comprising the CNT phase; and a support phase 320, comprising the support material, that completely covers the CNT phase in a core-sheath geometry along the longitudinal direction of the fishing line 300. For example, a sheath of support material of thickness t_{S} may be added to the diameter d₀ of the CNT filament 310 to increase the fishing line 300 to an overall diameter of d₃.

The interface between the CNT filament 310 and the support phase 320 may include a treated surface 312 of the CNT filament and/or a treated surface of the support phase 320. Alternatively, neither of the surfaces of the CNT filament 310 and the support phase 320 may be treated (e.g., no physical, chemical, mechanical treatments) before combining.

In one or more embodiments, the support phase 320 is not symmetrically disposed around the CNT filament 310. For example, the support phase 320 may have an asymmetrical thickness or may include multiple materials.

FIGS. 5A-5B each show a multi-filament fishing line 400, in accordance with one or more embodiments.

In FIG. 5A, the fishing line 400 includes: a CNT filament 410 comprising the CNT phase; and a support filament 420, comprising the support material, that is braided with the CNT filament 410 along the longitudinal direction of the fishing line 400.

The CNT filament 410 may be the same as any of the CNT filaments 110, 210, 310 described above. While a circular cross-sectional shape of diameter d_{4C} is shown, any cross-sectional shape, diameter, and/or dimensional measure may be used for the CNT filament 410.

The support filament 420 may be a monofilament or a multifilament. In one or more embodiments, the monofilament may be formed of a single material or a plurality of materials extruded as a filament. In one or more embodiments, the multifilament may be a thread twisted or braided fibers or a yarn formed of staple fibers. While a circular cross-sectional shape of diameter d_{4S} is shown, any cross-sectional shape, diameter, and/or dimensional measure may be used for the support filament 420. For example, a portion of the support filament 420 may conform to the surface geometry of the CNT filament 410 (e.g., applied in a soften or uncured state before completely bonding and finalizing the shape of the fishing line 400).

Furthermore, while the CNT filament 410 and support filament 420 are shown in roughly equal size (drawings are not to scale), any relative ratio of the filament diameter (or appropriate dimension) may be used. For example, a smaller CNT filament 410 may provide sufficient tensile strength to the fishing line 400 while a larger support filament 420 may provide the desired bending resistance to the fishing line 400. Thus, the fishing line 400 may be characterized by major and minor axis diameters (e.g., d_{4A} and d_{4B}, respectively) or an effective diameter of the twisted filaments.

The CNT filament 410 and the support filament 420 are braided together to form the multi-phase fishing line 400. In the context of this application, the term “braid” includes braid, twist, twist spin, or otherwise interleave components that form a singular object. The braid may be executed in any direction (clockwise or counterclockwise). By combining the two filaments, the best features of each respective material may improve the overall performance of the fishing line 400. For example, the CNT filament 410 provides greater tensile strength than the support filament 420 while the support filament 420 may have better environment resistance than the CNT filament 410.

In FIG. 5B, the fishing line 400′ includes: the CNT filament 410 comprising the CNT phase; and a plurality of support filaments 420a-f, each comprising a support material, that are braided with the CNT filament 410 along the longitudinal direction of the fishing line 400. By combining a plurality of filaments, the best features of a plurality of materials may improve the overall performance of the fishing line 400′.

In one or more embodiments, the fishing line 400′ includes a plurality of identical support filaments (i.e., 420a-f are the same material, diameters d_{4Sa-f} are the same), a plurality of unique support filaments (i.e., diameters d_{4Sa-f} are different and/or composition of 420a-f are different), or any combination thereof (e.g., multiple instances of one or more different support filaments).

While FIG. 5B shows six unique support filaments 420a-f, any number greater than one may be used (the case of N=1 is shown in FIG. 5A). Similar to fishing line 400, the braid in fishing line 400′ may be executed in any direction (e.g., clockwise or counterclockwise twisting/spinning/twist spinning) or ordered in any combination (e.g., braid sequence/complexity).

In one or more embodiments, the plurality of support filaments 420 may be radially distributed around the CNT filament 410. For example, the plurality of support filaments 420 may completely surround the CNT filament 410 in a core-sheath geometry along the longitudinal direction of the fishing line. The plurality of support filaments 420 may be distributed in a symmetrical or asymmetrical arrangement about the CNT filament 410.

In the above embodiments, the CNT filaments 210, 310, 410, 510 may be interchanged between the various embodiments. In other words, a feature (e.g., treated surface) of the CNT filament or CNT phase in any one of the above embodiments may be incorporated into a CNT filament or CNT phase of a different embodiment.

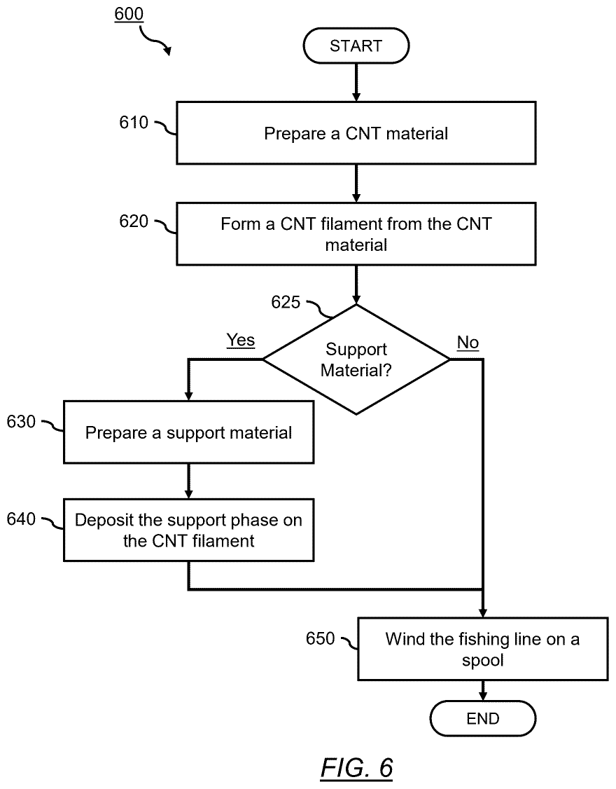

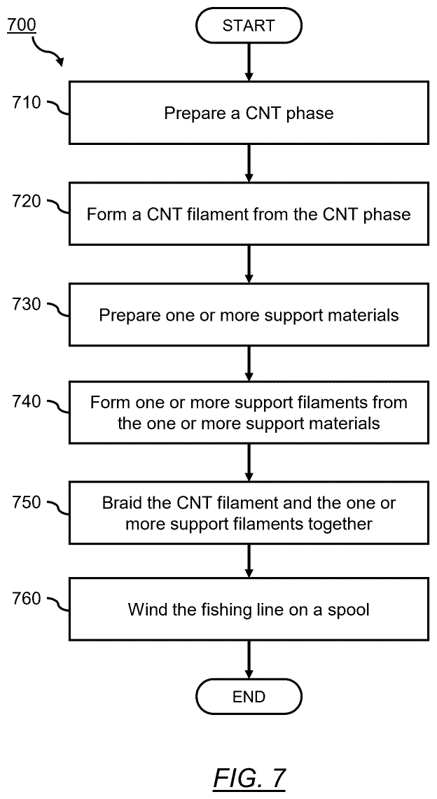

FIGS. 6-7 show flowcharts of methods for fabricating a fishing line, according to one or more embodiments.

In FIG. 6, a method 600 for fabricating a fishing line according to one or more embodiments (e.g., as shown in FIGS. 2-4) is shown.

At 610, a CNT material (e.g., a macroscopic proto-product) is prepared. For example, a CNT precursor (e.g., a solution containing a concentration of nanotubes of a predetermined length and diameter distribution) may be mixed with a solvent to for a CNT solvent. The solvent may be mixed (e.g., heated, agitated, etc.) to distribute the CNTs. The CNT solvent may be extruded, to partially align the individual CNTs, and cured or solidified to produce the CNT material.

At 620, the CNT material is formed into a CNT filament. For example, the CNT material may be cured, drawn, extruded, and/or twisted to further align the CNTs. A twist angle may be introduced into the CNT filament.

In one or more embodiments, the CNT filament may be subjected to a surface treatment process. For example, the CNT filament may be plasma etched, chemically etched, or physically abraded. One of ordinary skill in the art will recognize that other surface treatments may be devised that do not deviate from the scope of the present disclosure.

The treated surface of the CNT filament may be any portion of the total surface area of the CNT filament. In one or more embodiments, the treated surface may include the entire surface area of the CNT filament. In one or more embodiments where the treated surface does not include the entire surface area of the CNT filament, the treated surface may be a single contiguous region along the CNT filament. The treated surface may improve adhesion characteristics of the CNT filament.

At 625, a determination is made as to whether or not the fishing line will include a support material. In one or more embodiments where the determination at 625 is that a support material will be included (e.g., embodiments shown in FIGS. 3A-3C, 4), the process continues to 630. When the determination at 625 is that a support material will not be included (e.g., embodiments shown in FIG. 2), the process continues to 650.

At 630, a support material is prepared. The support material may include a synthetic polymer, a natural polymer, a ceramic, a carbon material other than the carbon nanotubes, or any combination thereof. In one or more embodiments, multiple materials may be combined (e.g., extruded, pelletized, melted, mixed) to form the support material.

At 640, the support material is deposited on the CNT filament. For example, the support material may be applied to the CNT filament by dip-coating (e.g., embodiments shown in FIGS. 3A and 4), spray-coating (e.g., embodiments shown in FIGS. 3A, 3C, 4), brush-coating (e.g., embodiments shown in FIGS. 3A and 4), or any combination thereof. In one or more embodiments, the CNT filament and the support material may be co-extruded to form a predetermined cross-sectional shape, as shown in FIG. 3B. One of ordinary skill in the art will recognize that other methods of combining the support material and the CNT filament may be devised that do not deviate from the scope of the present disclosure.

In one or more embodiments, depositing the support material may require further curing steps to finalize the fishing line. For example, a cooling or curing stage may be used to perform a final cure on the CNT phase and/or the support material.

At 650, the fishing line is wound onto a spool.

Although method 600 has been described with respect to a limited number of examples and operations, those skilled in the art, having benefit of this disclosure, will appreciate that various other embodiments may be devised without departing from the scope of the present disclosure.

In FIG. 7, a method 700 for fabricating a fishing line according to one or more embodiments (e.g., as shown in FIGS. 5A-5B) is shown.

At 710, a CNT phase (e.g., a macroscopic proto-product) is prepared. For example, a CNT precursor (e.g., a solution containing a concentration of nanotubes of a predetermined length and diameter distribution) may be mixed with a solvent to for a CNT solvent. The solvent may be mixed (e.g., heated, agitated, etc.) to distribute the CNTs. The CNT solvent may be extruded, to partially align the individual CNTs, and cured or solidified to produce the CNT phase.

At 720, the CNT phase is formed into a CNT filament. For example, the CNT phase may be cured, drawn, and/or twisted to further align the CNTs. A twist angle may be introduced into the CNT filament.

In one or more embodiments, the CNT filament may be chemically and/or mechanically treated. For example, the CNT filament may be plasma or corona etched, chemically etched, or physically abraded. One of ordinary skill in the art will recognize that other surface treatments may be devised that do not deviate from the scope of the present disclosure.

The treated surface of the CNT filament may be any portion of the total surface area of the CNT filament. In one or more embodiments, the treated surface may include the entire surface area of the CNT filament. In one or more embodiments where the treated surface does not include the entire surface area of the CNT filament, the treated surface may be a single contiguous region along the CNT filament. The treated surface may improve adhesion characteristics of the CNT filament.

At 730, one or more support materials are prepared. Each support material may include a synthetic polymer, a natural polymer, a ceramic, a carbon material other than CNTs, or any combination thereof. In one or more embodiments, multiple instances of a single material or multiple different materials may be prepared.

At 740, the one or more support materials are formed into one or more support filaments. For example, each support material may be cured, drawn, extruded, etc. to form one or more support filaments.

At 750, the CNT filament and the one or more support filaments are braided together. In other words, the CNT filament and the one or more support filaments are twisted, twist spun, or otherwise interleaved to form the fishing line. The braid may be executed in any direction (clockwise or counterclockwise, s/z twist).

At 760, the fishing line is wound onto a spool.

Although method 700 has been described with respect to a limited number of examples and operations, those skilled in the art, having benefit of this disclosure, will appreciate that various other embodiments may be devised without departing from the scope of the present disclosure.

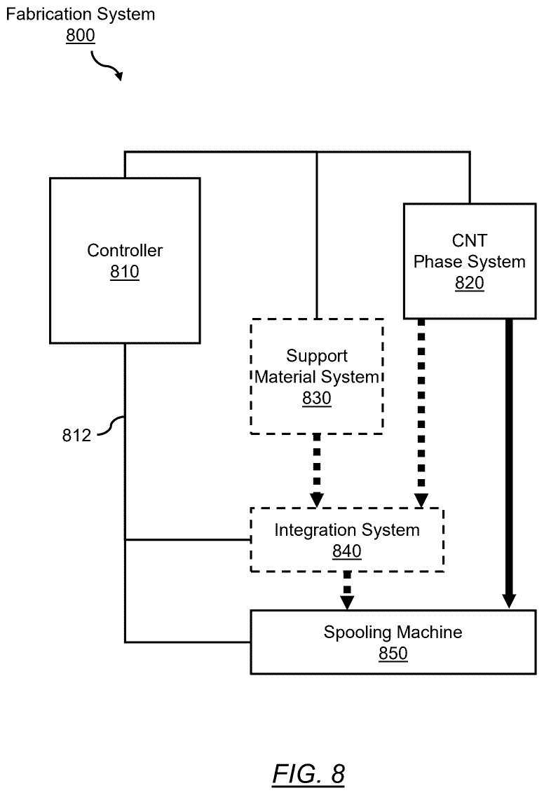

While the various blocks in FIGS. 6-7 are presented and described sequentially, one of ordinary skill in the art will appreciate that some or all of the blocks may be executed in different orders, combined, omitted, and some or all of the blocks may be executed in parallel. The methods of FIGS. 6-7 may be implemented using instructions stored on a non-transitory medium that may be executed by a controller, a processor, or a computer system, as discussed in further detail below with respect to FIG. 8.

FIG. 8 shows a system 800 for fabricating a fishing line according to one or more embodiments.

In one or more embodiments, the fabrication system 800 includes a controller 810 that controls a CNT phase system 820 and a spooling machine 850. In one or more embodiments, the system 800 may further include a support material system 830 and an integration system 840. Each of these components is described in further detail below.

The controller 810 manages the other components of the system 800. The controller 810 may control the actions of each component in the system 800 (e.g., activated/deactivate, regulate operational parameters) and coordinate the exchange of work product components (e.g., control input/output rates, switch feed lines, schedule interactions).

The controller 810 may be a centralized controller that controls the various components of the system 800 or may be a plurality of distributed controllers that individually control components of the system 800 in a synchronized manner.

The controller 810 may include one or more processors, a programmable logic controllers (PLCs), computer systems, servers, or any combination thereof that can govern the components of the system 800. The controller 810 may be implemented in hardware (i.e., circuitry), software, or any combination thereof. The controller 810 may execute instructions for operations based on the flowcharts of FIGS. 6-7.

The controller 810 may be configured to communicate with the components of the system 800 via a network 812. The controller 810 may receive information related to the operations of the components of the system 800 (e.g., operational parameters, power information, status information, or any other appropriate data) via the network 812 to determine the appropriate instructions and timing for the above described operations.

The network 812 may be a wired or wireless network (e.g., a local area network (LAN), a wide area network (WAN) such as the Internet, mobile network, or any other type of network) and implemented via one or more network interface connections (e.g., a structural transceiver such as a communication port or antenna) (not shown).

The CNT phase system 820 prepares a CNT material and/or the CNT filament used in fabricating the fishing line. The CNT phase system 820 may accept one or more of the following as inputs: a CNT precursor, a CNT solution, a solvent, a dopant, or any other supplies necessary to prepare the CNT material or the CNT filament. The CNT phase system 820 may output a partially or fully cured CNT filament. The subcomponents of the CNT phase system 820 are described in further detail below with respect to FIG. 9A.

The support material system 830 prepares the support phase and/or the support filament used in fabricating the fishing line. The support material system 830 may accept one or more of the following as inputs: a polymer feedstock, a polymer solution, a solvent, a dopant, a polymer filament, a metal feedstock, or any other supplies necessary to prepare the support phase or the support filament. The support material system 830 may output a support material, a support phase, and/or a support filament. The subcomponents of the support material system 830 are described in further detail below with respect to FIG. 9B.

The integration system 840 combines the outputs of the CNT phase system 820 and the support material system 830 to form the finished fishing line. The integration system 840 may further accept any other supplies necessary to prepare the fishing line or combine the CNT filament, the support phase, and/or the support filament. The integration system 840 may outputs the fully formed fishing line. The subcomponents of the integration system 830 are described in further detail below with respect to FIG. 9C.

The spooling machine 850 accepts the finished fishing line. In one or more embodiments, the spooling machine 850 accepts the CNT filament from the CNT phase system 820 as the finished fishing line. In one or more embodiments, the spooling machine 850 accepts a finished fishing line from the integration system 840, where the finished fishing line include a CNT phase (e.g., a CNT filament) and a support phase (e.g., a support filament braided with the CNT filament, support material applied to the CNT filament). The spooling machine 850 may include one or more rollers, guides, motors, spindles, and bobbins to wind or collect the fishing line onto one or more spools.

FIGS. 9A-9C show subsystems for fabricating a fishing line according to one or more embodiments.

FIG. 9A shows a CNT phase system 820 according to one or more embodiments. As discussed above, the CNT phase system 820 prepares a CNT material and the CNT filament used in fabricating the fishing line. Therefore, the CNT phase system 820 may include one or more of: a mixer 822, an extruder 824, a curing station 826, and a surface treatment station 828. Each of these subcomponents is described in further detail below.

The mixer 822 mixes input materials such as a CNT precursor, a CNT solution, a solvent, a dopant, an emulsifier, a resin, an epoxy, a lubricant, a glue, an additive, or any other supplies necessary for preparation of a CNT material that is to be formed into the CNT phase of the fishing line (e.g., a CNT filament). The mixer 822 may further include a heater, a cooler, an agitator, a sonicator, or any other appropriate equipment to mix materials or distribute CNTs.

The extruder 824 extrudes the CNT material to partially align the individual CNTs. The extruder 824 may further include equipment to draw and/or twist the CNT material into a CNT filament (e.g., to further align the CNTs or define a predetermined twist angle of the CNT filament).

The curing station 826 includes equipment (e.g., light/heat/radiation source, cooling bath) to solidify or cure the CNT material or the CNT filament during any processing stage.

The surface treatment station 828 includes equipment to modify the physical characteristics or chemical reactivity of the CNT filament. In one or more embodiments, the surface treatment station 828 may include one or more of the following: a plasma etching chamber (e.g., an ion etching chamber and load lock system to pass the CNT filament, a chemical etching chamber (e.g., wet chemical bath with equipment to dip CNT filament), and a mechanical abrading system (e.g., abrasive material physically applied to the CNT filament to roughen the surface). The surface treatment station 828 may prepare the CNT filament prior to integration with the support phase of the fishing line.

In one or more embodiments, the CNT phase system 820 is based on a chemical vapor deposition (CVD) process (e.g., floating catalyst CVD). The mixer 822 and extruder 824 may be a heated reactor tube. The reactor tube may be any material (e.g., alumina, mullite) and is heated (e.g., >1000° C.) to decompose source materials into a CNT aerogel. For example, a first end of the reactor tube may be fed with a carbon source (e.g., butanol), a metal catalyst source (e.g., ferrocene), a promotor source (e.g., thiophene as a sulfur promotor), and a carrier gas (e.g., hydrogen gas) that are heated to form the aerogel. After nucleation within the aerogel, spinning and drawing of a continuous CNT fiber from a second end of the reactor tube can be continuous performed. Source feedstock ratios, source material selection, reactor parameters (e.g., temperature, material), and/or draw rate may be controlled to affect properties of the CNTs (e.g., wall layers, diameter, linear density, nanotube type/morphology) and the output CNT fiber/filament.

In one or more embodiments, the CNT phase system 820 is based on a solvent based extrusion process. The mixer 822 may include one or more processing units that blend an unaligned CNT material (e.g., CNT molecules dispersed in a feedstock material) with a solid or liquid solvent. The mixer 822 outputs a dope solution with a controlled CNT density or concentration. The mixer may include one or more feeders that accepts the unaligned CNT material, solvents, other precursors, one or more active (e.g., paddles, blades) or passive (e.g., container geometry) blending elements to mix the feedstock material, one or more heat/pressure sources (e.g., heater, constrictions) to prepare the solvent (e.g., melt a solid solvent), one or more filters to add or remove material (i.e., alter the composition of the output dope solution). The extruder 824 mixes, homogenizes, and converts the dope solution into a secondary product with at least partially aligned CNTs therein. The extruder 824 may include one or more flow manifold that aligns the CNTs while passing the dope solution, one or more filters for purifying the dope solution, and an extrusion die for outputting the secondary product. The curing station 826 may convert the secondary product into an aligned CNT filament/fiber. The curing station 826 may include one or more rollers/drums for aligning CNTs by drawing/spinning and one or more physical or chemical unit (e.g., oven, radiation source, chemical applicator/evacuator) for drying/filtering of the secondary product.

FIG. 9B shows a support material system 830 according to one or more embodiments. The support material system 820 may include one or more of: a mixer 832, an extruder 834, a curing station 836, and a post processing station 838. Each of these subcomponents is described in further detail below.

The mixer 832 mixes one or more of the following: a precursor material, a solvent, a dopant, an emulsifier, a resin, an epoxy, a lubricant, a glue, an additive, or any other supplies necessary for preparation of a support material that is to be formed into the support phase or support filament of the fishing line. The mixer 822 may further include a heater, a cooler, an agitator, a sonicator, or any other appropriate equipment to prepare the support material for deposition on the CNT filament or formation into a support filament.

The extruder 834 extrudes a support material into a support filament. In one or more embodiments of the fishing line that include a support filament, the extruder 834 produces the one or more support filaments that are to be integrated with the CNT phase of the fishing line (e.g., the CNT filament output of the CNT phase system 810).

The curing station 836 includes equipment (e.g., light/heat/radiation source, cooling bath) to solidify, cure, and/or soften the support material or the support filament during any processing stage.

The post processing station 838 includes equipment to modify the physical characteristics or chemical reactivity of the support material or the support filament. In one or more embodiments, the post processing station 828 may include one or more of the following: a plasma etching chamber (e.g., an ion etching chamber and load lock system, a chemical etching chamber (e.g., wet chemical bath), and a mechanical abrading system (e.g., abrasive material to roughen the surface). Similar to the surface treatment station 828, the post processing station 838 may prepare the support material or the support filament prior to integration with the CNT phase of the fishing line.

FIG. 9C shows an integration system 840 according to one or more embodiments. The integration system 840 may include one or more of: a coating system 842, an extruder 844, a curing station 846, and a braiding station 848. Each of these subcomponents is described in further detail below.

The coating system 842 applies the support material to the CNT filament to form the support phase of the fishing line. In one or more embodiments, the CNT filament output from the CNT phase system 820 and a support material output from the support material system 830 are input into the integration system 840. The coating system 842 may include one or more of: a system to draw the CNT filament through a liquid support material to cover the surface of the CNT filament partially or completely (e.g., a dip coating system); a system to spray a liquid or aerosolized support material onto the CNT filament to partially or completely cover the surface of the CNT filament (e.g., a spray coating system); a system to paint or otherwise apply a liquid support material to onto the CNT filament to partially or completely cover the surface of the CNT filament (e.g., a brush coating system).

The co-extruder 844 forms the fishing line by combining the support material and CNT filament into a single filament. In one or more embodiments, the CNT filament output from the CNT phase system 820 and a support material output from the support material system 830 are input into the integration system 840. The co-extruder 844 may melt the support material and extrude the molten support material and the CNT filament through a die to form a fishing line with a predetermined cross-sectional shape. The relative amount of the CNT phase and the support phase of the extruded fishing line may be controlled by the size and shape of the extrusion die.

The curing station 846 includes equipment (e.g., light/heat/radiation source, cooling bath) to solidify, cure, and/or soften the support material or the support filament during any processing stage.

The braiding station 848 forms the fishing line by braiding together one or more support filaments and one or more CNT filaments. In one or more embodiments, the CNT filament output from the CNT phase system 820 and support filament output from the support material system 830 are input into the integration system 840. The braiding station 848 may include one or more systems for twisting, twist spinning, or otherwise interleaving any number of input filaments (wet or dry) into the final fishing line. The braiding may be executed in one or more stages, where each stage may be independently controlled.

While FIGS. 9A-9C show various configurations of subcomponents, other configurations may be used without departing from the scope of the disclosure. For example, the subcomponents shown in FIGS. 9A-9C may be combined into a single system or distributed (with connecting infrastructure). Each component of the fabrication system 800 may include additional subcomponents such as power supplies, controllers, transformers, switches, indicators, pulleys, ramps, guides, etc. Various subcomponents in FIGS. 9A-9C may be combined to create a single subcomponents. In addition, the functionality of each subcomponents described above may be shared among multiple subcomponents or performed by a different subcomponents than that described above. Each subcomponent may be utilized multiple times (e.g., in serial, in parallel, distributed locally or remotely) to perform the functionality of the claimed invention. Furthermore, in certain embodiments, one or more subcomponents may be omitted when the functionality is not required to produce the fishing line (e.g., a co-extruder 844 may be omitted in embodiments that only require the CNT phase and support phase to be braided together).

One or more of the embodiments of the disclosure may have one or more of the following advantages: improved tensile strength in fishing line technology; improved modulus in fishing line technology, provide mechanical strength and chemical resistance over conventional high strength metal fishing lines.

Although the disclosure has been described with respect to a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A fishing line comprising:
a carbon nanotube (CNT) filament that includes a CNT phase,
wherein the CNT phase includes CNTs extending along a longitudinal direction of the CNT filament, and
wherein the fishing line has a tensile strength greater than or equal to 1 [GPa].

2. The fishing line of claim 1,
wherein the CNT filament further includes a support phase, and
wherein the support phase includes a support material.

3. The fishing line of claim 2,
wherein the CNT phase is covered by the support phase along the longitudinal direction of the CNT filament.

4. The fishing line of claim 3,
wherein the CNT phase includes functional groups which improve adhesion with the support phase

5. The fishing line of claim 3,
wherein the CNT phase includes an abraded surface, and
wherein the abraded surface is covered by the support phase.

6. The fishing line of claim 2,
wherein the support material includes a synthetic polymer, a natural polymer, a ceramic, a metal, or a carbon material other than CNTs.

7. The fishing line of claim 1, further comprising:
a support filament that includes a support material,
wherein the CNT filament and the support filament are braided together.

8. The fishing line of claim 7,
wherein the fishing line includes a plurality of identical support filaments braided together with the CNT filament.

9. The fishing line of claim 7,
wherein the fishing line includes a plurality of support filaments braided together with the CNT filament, and
the plurality of support filaments are distributed around the CNT filament.

10. A method of fabricating a fishing line, the method comprising:
preparing a carbon nanotube (CNT) material comprising a plurality of CNTs;
forming a CNT filament from the CNT material by imparting alignment to the CNTs along a longitudinal direction of the CNT filament;
forming the fishing line with the CNT filament; and
winding the fishing line on a spool,
wherein the fishing line is formed with a tensile strength greater than or equal to 1 [GPa].

11. The method of claim 10, further comprising:
mixing a solvent and the CNTs to produce the CNT material,
wherein forming the CNT filament includes extruding the CNT material to impart alignment to the CNTs along with the longitudinal direction of the CNT filament.

12. The method of claim 10, further comprising:
preparing a support material,
wherein forming the CNT filament includes combining the CNT material and a support phase that includes the support material.

13. The method of claim 12,
wherein combining the CNT material and the support phase includes depositing the support phase to at least partially cover the CNT phase along the longitudinal direction of the fishing line.

14. The method of claim 12, further comprising:
imparting functional groups on the surface of the CNT material that interact with the support phase.

15. The method of claim 14,
wherein the functional groups are imparted by a plasma treatment, a corona treatment, or a chemical treatment of the CNT material.

16. The method of claim 12, further comprising:
increasing surface area contact between the support phase and the CNT material by abrading the surface of CNT material.

17. The method of claim 11,
wherein preparing the support material includes preparing a synthetic polymer, a natural polymer, a ceramic, metal, or a carbon material other than CNTs.
